(19) United States
(12) Patent Application Publication
(10) Pub. No.: US 2017/0228231 A1
(43) Pub. Date: Aug. 10, 2017

(54) Identification and Association Method and System

(71) Applicant: MASTERCARD INTERNATIONAL INCORPORATED, Purchase, NY (US)

(72) Inventors: Siddhesh Pangam, Tal-Kankavli (IN); Tushar Uddhav Gaikar, Mumbai (IN); Karabi Ghanta, Mumbai (IN)

(21) Appl. No.: 15/423,244

(22) Filed: Feb. 2, 2017

(30) Foreign Application Priority Data
Feb. 4, 2016 (SG) 10201600877T

(51) Int. Cl. G06F 9/445; G06F 21/62; H04L 29/08

(52) U.S. Cl. CPC G06F 8/65; H04L 67/303; G06F 21/629

(57) ABSTRACT

A method for identifying at least one asset associated with an application program, each of the at least one asset having at least one electronic asset processing device configured to at least partially interact with the application program, is provided. The method includes determining a unique application identifier indicative of an identity of the application program, retrieving at least one asset identifier from an identifier store using the unique application identifier, the at least one asset identifier being indicative of the at least one asset. The method also includes providing an indication of the at least one asset identifier to thereby allow the at least one asset to be identified.

### CROSS REFERENCE TO RELATED APPLICATIONS

This application claims the benefit of Singapore Patent Application No. SG10201600877T filed Feb. 4, 2016, which is hereby incorporated by reference in its entirety.

### BACKGROUND

The present disclosure relates to a method and system for identifying assets associated with an application program, and a method and system for associating assets with an application program, where the assets have an electronic asset processing device configured to at least partially interact with the application program.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavor to which this specification relates.

Information Technology (IT) infrastructure within organizations can include multiple application programs operating over numerous assets, such as database servers, web servers, and application servers. In such situations, changes to an application program or asset can seriously impact IT operations, particularly where the relationships between the changed program or asset, and other assets, is not fully considered.

In addition, some organizations task different departments with the management of different aspects of IT infrastructure. Consequently, for example, teams responsible for maintaining asset hardware, maintaining operating systems, and the like, can create issues such as outages for application programs where the relationship between the respective assets and application programs is not considered and/or where changes are not adequately communicated among teams.

### BRIEF DESCRIPTION

In a first aspect, a method for identifying at least one asset associated with an application program, wherein each of the at least one assets has at least one electronic asset processing device configured to at least partially interact with the application program, is provided. The method includes, in at least one electronic processing device, determining a unique application identifier indicative of an identity of the application program, retrieving at least one asset identifier from an identifier store using the unique application identifier, the asset identifier being indicative of the at least one asset, and providing an indication of the at least one asset identifier to thereby allow the assets to be identified.

In some embodiments, the method includes determining the unique application identifier in accordance with user input commands.

In other embodiments, retrieving the asset identifier includes, in the electronic processing device, retrieving an association from the identifier store, the association being indicative of the unique application identifier and the at least one asset identifier, and determining the at least one asset identifier using the association.

In yet other embodiments, the method includes, in the electronic processing device, receiving an asset request via a communications network from a requesting device, the asset request including an indication of the application identifier, and providing the indication of the at least one asset identifier to the requesting device via the communication network.

In some embodiments, interacting with the application program includes at least one of operating the application program; executing the application program, and interfacing with the application program.

In other embodiments, the method includes, in the electronic processing device, determining an environment identifier indicative of an application environment of the application program, retrieving the asset identifier from the identifier store using the environment identifier and the unique application identifier, retrieving at least one application property from the identifier store using the unique application identifier, providing an indication of the application property, receiving an application update request to update an application property, the request including an updated application property value, updating the application property with the updated application property value, and selectively indicating whether the update was successful.

In yet other embodiments, the application property includes at least one of: an application name, an application short name, an application owner/team, an application environment, an approver, an organization, an application contact, and a line of business.

In some embodiments, the method includes, in the electronic processing device, retrieving at least one asset property from the identifier store, the asset property being indicative of a property of the asset using the asset identifier, providing an indication of the at least one asset property, receiving an asset update request to update an asset property, the request including an updated asset property value, updating the asset property with the updated asset property value, and selectively indicating whether the update was successful.

In other embodiments, the asset property includes at least one of: at least one version identifier, a version history, a patch history, a patch identifier, an operating system identifier, a hardware specification, and a hardware identifier.

Furthermore, the method includes, in the electronic processing device, receiving an asset disassociate request to disassociate at least one of the at least one assets from the application program, the request including respective asset identifiers, disassociating the respective asset identifier and the unique application identifier in the identifier store, selectively indicating whether the disassociation was successful, receiving an application disassociate request to disassociate the application, the request includes the unique application identifier, disassociating the unique application identifier and each of the at least one asset identifiers in the identifier store, and selectively indicating whether the disassociation was successful. Disassociating can include at least one of decommissioning, removing, and deleting.

In addition, the method may include, in the electronic processing device, receiving a request from a requesting device, the request including an authorization parameter, comparing the authorization parameter and at least one of the application properties, selectively authorizing the request based upon the results of the comparison, receiving a request from a requesting device, determining at least one application property indicative of an authority, requesting authorization from an authorizing device via a communications network using the application property, and selectively authorizing the request based upon the results of the authorization.

In some embodiments, the asset includes any one of: a web server; an application server; and a database server.

A method for associating at least one asset with an application program, wherein each of the at least one assets has at least one electronic asset processing device configured to at least partially interact with the application program, is provided. The method includes, in the at least one electronic processing device, determining a unique application identifier indicative of an identity of the application program, determining at least one asset identifier indicative of the identity of the at least one asset, associating the at least one asset identifier and the unique application identifier, and storing the association in an identifier store, thereby associating the at least one asset and the application program.

In some embodiments, determining a unique application identifier includes at least one of: generating a unique value, and retrieving a unique value from a store. Determining the unique application identifier may include, in the electronic processing device, generating a unique value at least partially using an environment identifier, the environment identifier being indicative of an application environment.

In another aspect, a method for identifying at least one application program associated with an asset, wherein the asset has at least one electronic asset processing device configured to at least partially interact with the application program, is provided. The method includes, in at least one electronic processing device, determining at least one asset identifier indicative of the identity of the at least one asset, retrieving at least one unique application identifier from an identifier store using the at least one asset identifier, each unique application identifier being indicative of one of the at least one application programs and providing an indication of the at least one unique application identifier to thereby allow the at least one application to be identified.

A system for identifying a plurality of assets associated with an application program, wherein each asset includes at least one electronic asset processing device configured to at least partially interact with the application program, is provided. The system includes an identifier store; and, at least one electronic processing device that: determines a unique application identifier indicative of the identity of the application program, retrieves a plurality of asset identifiers from the identifier store using the unique application identifier, each asset identifier being indicative of at least one of the plurality of assets, and provides an indication of the asset identifiers to thereby allow the assets to be identified.

In some embodiments, retrieving the asset identifier includes, in the electronic processing device, retrieving an association from the identifier store, the association being indicative of the unique application identifier and the at least one asset identifier, and determining the at least one asset identifier using the association.

A system for associating a plurality of assets with an application program, wherein each asset including at least one electronic asset processing device configured to at least partially interact with the application program, is provided. The system includes an identifier store, and at least one electronic processing device that determines a unique application identifier indicative of an identity of the application program, determines an asset identifier indicative of the identity of each of the plurality of assets, associates each of the asset identifiers and the unique application identifier, and stores each association in the identifier store, thereby associating the assets and the application program.

### BRIEF DESCRIPTION OF THE DRAWINGS

An example of the present disclosure will now be described with reference to the accompanying drawings, in which:

FIG. 1A is a flow chart of an example of a method for identifying one or more assets associated with an application program;

FIG. 1B is a flow chart of an example of a method for associating one or more assets with an application program;

FIG. 2 is a schematic diagram showing components of an example electronic processing device;

FIG. 3 is a schematic diagram showing components of an example system for identifying one or more assets associated with an application program, or for associating one or more assets with an application program;

FIG. 4 is a dataflow diagram of an example of data flow in an system for identifying one or more assets associated with an application program, or associating assets with the application program;

FIG. 5 is a flow chart of an example of a method for managing change requests for an application program and/or associated asset;

FIG. 6 is a flow chart of an example of a method for managing requests to patch one or more assets associated with an application program;

FIG. 7 is a flow chart of an example of a method for managing requests to patch an application associated with one or more assets; and

FIG. 8 is a schematic diagram showing components of a further example of an electronic processing device.

### DETAILED DESCRIPTION

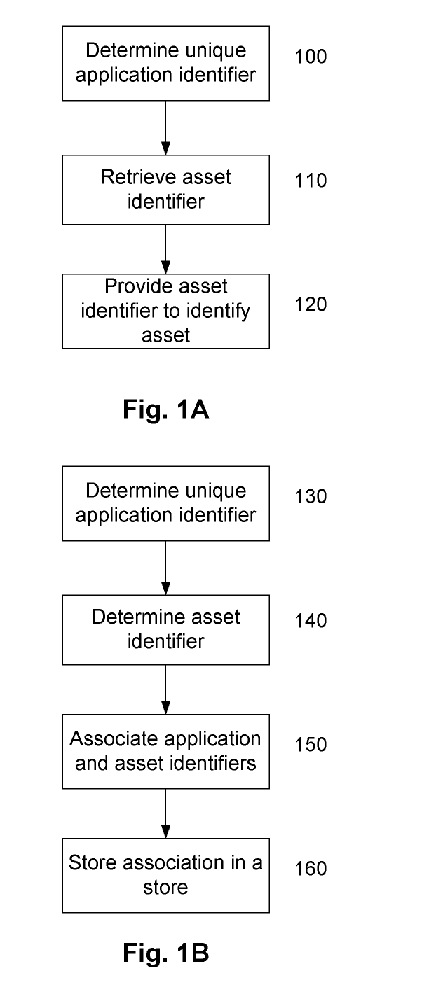

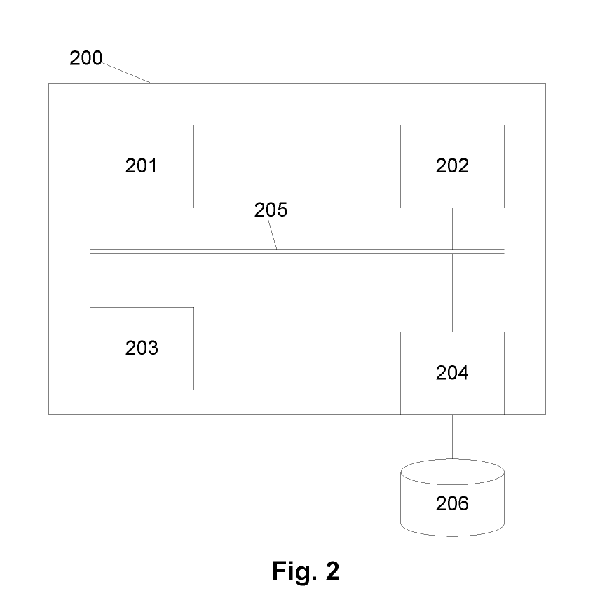

An example of a method for identifying one or more assets associated with an application program, and a method for associating one or more assets with an application program, will now be described with reference to FIGS. 1A, 1B and 2.

In these examples, each of the assets has one or more electronic asset processing devices configured to at least partially interact with the application program. Interaction with the application program may include any suitable form of interaction, such as operating and/or executing the application program, interfacing with the application program, providing an upstream source or dependency, or downstream target or dependency, to the application program, or the like. Accordingly, each of the electronic asset processing devices may include one or more physical electronic processing devices, one or more virtual realizations of electronic processing device(s), virtualized electronic processing device(s), virtual machines (VM), software provided by VMWare™, or the like, one or more cloud based services and/or software, or the like, and this will be discussed below in more detail.

In addition, in the examples of FIG. 1A and FIG. 1B, the method includes steps performed in at least one electronic processing device. The electronic processing device in this regard may also include one or more physical or virtualized electronic processing devices and/or cloud based software/services, as discussed above.

In FIG. 1A, the method for identifying one or more assets associated with an application program includes, in the electronic processing device, at step 100 determining a unique application identifier indicative of an identity of the application program. In this regard, the unique application identifier uniquely identifies the application program, and as such may be composed of any suitable representation including a value such as a number, a set of alphanumeric characters, a character string, or the like, and/or a reference, for example, to a value. As will be discussed further below, the unique application identifier may be determined in any suitable manner in this method, including in accordance with user input commands, receiving an asset request from a requesting device, retrieving the application identifier from a store or memory, or the like.

At step 110, the method includes, in the electronic processing device, retrieving one or more asset identifiers from an identifier store using the unique application identifier, the asset identifier being indicative of the one or more assets. Each asset identifier may be indicative of one asset, or a plurality of assets, such as a list or group of assets. Thus, the identifier store may be formed in any suitable manner, such as at least part of one or more physical or virtualized memory devices, cloud based store/memory, or the like, where the memory is arranged in any suitable form, such as a repository, database, relational database, or the like, and typically includes associations between asset identifiers and unique application identifiers of corresponding applications. Thus, in one example, the asset identifier(s) is/are retrieved by providing a query to the identifier store where the query includes the unique application identifier, and receiving the results of the query, including one or more asset identifiers, from the identifier store.

At step 120, the method includes providing an indication of the asset identifier to thereby allow the assets to be identified. This may be achieved in any suitable manner, and may include sending the indication to a requesting device, or providing the indication to a user, such as via a display, communication network, or the like, and this will be discussed further below.

Thus, the abovementioned method is particularly advantageous as it provides a list of associated assets for an application program using a unique application identifier. Using an application identifier which is unique minimizes the risk that an application program will be mistaken for another program, and consequently that changes imposed on the mistaken application program or its associated assets will have unforeseen operational impacts.

An organization may include numerous assets including hardware and software IT assets, such as one or more servers, web servers, application servers, database servers, workstations, notebook assets, computers, computer networks, network devices, routers, switches, firewalls, virtual infrastructure, infrastructure services, drivers, firmware, hard drives, hosted virtual machines, logical volumes, network interfaces, operating systems, peripherals, processors, removable media, storage controllers, and the like.

Additionally, the examples herein may also apply to assets which do not necessarily include an electronic asset processing device, such as physical cabling, connectors, internet connections, ports, USB controllers, and the like, as well as electronic files, such as licenses, databases, memory, graphics and audio, text files, other documents/files, and the like. The electronic files may also belong to application assets that are associated with at least one application program.

Moreover, such an organization may include a myriad of application programs operating across one or more lines of business and interacting with any one or more of assets, such as any one or more of accounting, data management, documentation, enterprise resource planning, financial, project management, educational, simulation, media development, or product engineering software, as well as enterprise infrastructure software, such as Microsoft™ Exchange™, Active Directory, Microsoft Sharepoint™, or the like.

Thus, in large organizations the relationship between application programs and the asset(s) with which they interact can be particularly complex and not readily apparent. Changes or modifications to an application program and/or asset can, therefore, have unplanned, unintended, and potentially serious, impacts on IT operations, where these relationships are not appropriately managed. For example, patching a web server may cause an outage in the application program which accesses that web server.

In addition, different IT professionals may be responsible for the maintenance of different application programs and assets. For example, a UNIX admin team may be responsible for managing the UNIX operating system (OS) on one or more assets, where the various application programs interacting with the UNIX assets are managed by separate application owners/teams. Any updates which the UNIX admin team deem necessary, for example, in order to ensure the UNIX assets include the latest security and performance updates, may, therefore, impact the interacting application programs. However, without adequate management or knowledge of the associations between the application programs and UNIX assets, any impacts will be difficult to predict and prevent.

Thus, the abovementioned method provides an effective way to manage the relationships between an application program and associated assets, including facilitating an understanding of the impact any proposed additions, changes, patches, removals, or updates may have on related programs and assets. In addition, the abovementioned method also enables the UNIX admin team to work with respective application teams for patching, updating, removal of application assets, and the like.

Furthermore, the method provides an identifier store which can be managed with oversight, for example, from an application program owner or other appropriate authority, such that additions, removals, and/or modifications can be restricted to those performed or approved by the owner, or at least with notification provided to the owner.

Whilst the above method describes identifying assets associated with an application program, in other examples, a method may be provided for identifying application programs associated with an asset and this will be discussed in more detail below.

The example of FIG. 1B provides the method for associating one or more assets and an application program. In this example, at step 130, the method includes in the electronic processing device determining a unique application identifier indicative of an identity of the application program. As discussed above, this may be achieved in any suitable manner, such as in accordance with user input commands. In some examples, the unique application identifier is generated, retrieved from a store, or the like and this is discussed further below.

At step 140, the method includes determining one or more asset identifiers indicative of the identity of the one or more assets. Also as discussed above, each asset identifier may be indicative of the identity of one asset, or a number of assets (such as a list or group of assets). Additionally, the asset identifiers may be determined in any suitable manner, including retrieving them from a store, in accordance with user input commands, and/or generating the identifiers. This will be described in more detail below.

The method includes associating the asset identifier(s) and the unique application identifier, at step 150. In some examples, this is achieved by generating a query defining the relationship between the unique application identifier and asset identifiers. However, this is not essential and, in other examples, associating includes composing a list including the application and asset identifiers, determining a reference between the application and asset identifiers, or the like.

At step 160, the method includes storing the association in an identifier store, thereby associating the assets and the application program. Thus, according to some of the examples discussed above, this may include providing the query, list, reference or the like to the identifier store.

Hence, FIG. 1B advantageously provides a method for associating an application program and assets, and storing the relationships in an identifier store. Accordingly, the identifier store of this example may be utilized to identify associated assets, for example, using the method of FIG. 1A.

An example of a suitable electronic processing device for performing the method of FIGS. 1A and/or 1B (and/or a suitable electronic asset processing device) is shown in FIG. 2. In this example, the processing device 200 includes at least one microprocessor 201, a memory 202, and an external interface 204, interconnected via a bus 205 as shown. Optionally, the device 200 may also include one or more input/output (I/O) devices 203, such as a display, keyboard, touchscreen, and the like. In this example the external interface 204 can be utilized by the processing device 200 when communicating with peripheral devices, such as the identifier store 206, communications networks, requesting devices, other databases, other storage devices, or the like. Whilst in this example, the identifier store 206 is external to the electronic device 200, in a further example, the memory 202 may include the identifier store and/or the identifier store 206 may be included as an additional component in the electronic device 200. Although only one external interface 204 is shown, this is for the purpose of example only, and in practice multiple interfaces using various methods (e.g., Ethernet, serial, USB, wireless, Bluetooth™, or the like) may be provided.

In use, the microprocessor 201 executes instructions in the form of applications software stored in the memory 202 to allow communication with the identifier store 206, for example to retrieve asset identifiers, and optionally with requesting devices, for example, to receive asset requests.

Accordingly, it will be appreciated that the processing device 200 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. The processing device 200 may also be formed from a suitably programmed PC, Internet terminal, lap-top, or hand-held PC, a tablet, or smart phone, or the like. Thus, in one example, the processing system 200 is a standard processing system, such as an Intel Architecture based processing system, which executes software applications stored on non-volatile (e.g., hard disk) storage, although, this is not essential.

A number of further features of the abovementioned methods will now be described.

As discussed above, in some examples, the method includes determining the unique application identifier in accordance with user input commands. For example, the unique application identifier may be at least partially provided by the user input commands, generated using and/or in response to the user input commands, or retrieved in response to the user input commands. The user input commands may be received from a remote electronic device, for example, via a communication network, from an I/O device in communication with the electronic processing device, retrieved from a store or memory, or the like.

In one example, retrieving the asset identifier includes, in the electronic processing device, retrieving an association from the identifier store, the association being indicative of the unique application identifier and asset identifier(s), and determining the asset identifier(s) using the association. For example, the association may include a data structure including and/or referring to the unique application identifier and asset identifier, such as a list, group, linked list, reference, pointer, or the like. However, in other examples the method may include retrieving the asset identifier without necessarily retrieving an association.

In a further example, the method includes receiving an asset request via a communications network from a requesting device, the asset request including an indication of the application identifier, and providing the indication of the at least one asset identifier to the requesting device via the communication network. In this example, the requesting device typically includes an electronic processing device, and a suitable device in this regard is described in any of the examples herein. Thus, this feature facilitates, for example, remote requesting devices to access information in the form of asset requests from the identifier store.

Indeed, other types of requests may be received from a requesting device via a communications network, for example, any of the requests described herein including application requests, patch requests, change requests, and the like. Thus, in some examples, the identifier store may be accessed by multiple users operating respective requesting devices, who are responsible for different aspects of IT infrastructure within an organization. This is advantageous as each user is, therefore, able to access a single source of information regarding application program and asset relationships, for example, the identifier store, which is up-to-date and consistent.

In some examples, the method includes determining an environment identifier indicative of an application environment of the application program, and retrieving the asset identifier from the identifier store using the environment identifier and the unique application identifier. Therefore, this feature is particularly beneficial in identifying assets associated with an application program in a particular application environment. For example, in some instances it may be desirable to identify the assets associated with an application program in the development environment in order to perform patching, or the like, which does not effect production environments. In other examples, the environment identifier may form part of the unique application identifier, and this is described further below.

### Determining Identifiers

In some examples, determining a unique application identifier includes generating a unique value or retrieving a unique value from a store. For example, generating the unique value may include generating a random or pseudo-random number or sequence of characters, generating the unique value based upon properties of the application program (such as an application name or a hash of application code or content), or generating the unique value based upon a previous unique application identifier (for example, by incrementing a previously generated identifier). In addition, retrieving the unique value may include retrieving the value from a store (such as the identifier store), or may be achieved in accordance with a mapping algorithm, or the like.

Additionally or alternatively, in some examples determining the asset identifier(s) may be achieved in any suitable manner including generating a value and/or retrieving a value from a store. For example, generating the unique value may include generating a random or pseudo-random number or sequence of characters, generating the value based at least partially upon properties of the asset (such as an asset specification), or generating the unique value based upon a previous asset identifier (for example, by incrementing a previously generated value). In addition, retrieving the unique value may include retrieving the value from a store (such as the identifier store), or may be achieved in accordance with a mapping algorithm, or the like. The asset identifier could also be based on physical properties of the asset, such as a network address, MAC address, name, or the like.

### Properties

In a further example, the method includes retrieving at least one application property from the identifier store using the unique application identifier, and providing an indication of the application property. In this regard, the application property may include any suitable property, such as one or more of an application name, an application short name, an application owner/team, an application environment, an approver, an authority, an organization, an application contact, and a line of business. Thus, in some examples, the method allows properties of the application to be conveniently stored and maintained in a single source (for example, the identifier store).

Thus, the method may also facilitate the update, change, creation and/or deletion of application properties, and this will be discussed further below.

In one example, the method includes receiving an application update request to update the application property, the request including an updated application property value, updating the application property with the updated application property value, and selectively indicating whether the update was successful. In some examples, the update request may include a request to create a new application property in respect of the application program, thus updating the application property may also include creating the application property.

In a further example, the method includes retrieving at least one asset property from the identifier store, the asset property being indicative of a property of the asset, using the asset identifier, and providing an indication of the at least one asset property. Asset properties may include, for example, any one or more of at least one version identifier, a version history, a type, a make, specification(s), a patch history, a patch identifier, an operating system identifier, a hardware specification, and a hardware identifier.

Additionally or alternatively, the method may include receiving an asset update request to update the asset property, the request including an updated asset property value, updating the asset property with the updated asset property value, and selectively indicating whether the update was successful. As discussed above, an update request may also include a request to create a new asset property, which may be processing accordingly.

### Disassociation

In one example, the method includes receiving an asset disassociate request to disassociate one or more of the assets from the application program, the request including the respective asset identifiers. The method further includes disassociating the asset identifier and the unique application identifier in the identifier store, and selectively indicating whether the disassociation was successful.

In a further example, the method includes receiving an application disassociate request to disassociate the application, the request includes the unique application identifier. The method further includes disassociating the unique application identifier and each of the at least one asset identifiers in the identifier store, and selectively indicating whether the disassociation was successful.

In this regard, disassociating may include any one or more of decommissioning, disposing, removing, and/or deleting. Thus, these examples are particularly useful in reflecting changes to the IT infrastructure within the identifier store, for example, where assets have been decommissioned, application programs removed, or the like.

### Authorization and Notification

In some examples, it may be desirable to seek/provide authorization and/or provide notification in advance of changing any relationships, properties, or the like in the identifier store. Accordingly, in one embodiment any of the abovementioned methods may include receiving a request from a requesting device, the request including an authorization parameter, comparing the authorization parameter and one or more of the application properties, and selectively authorizing the request based upon the results of the comparison. The authorization parameter in this example may include any suitable parameter, and may be indicative of an identity or permission level of a requestor. The application properties may also include any suitable form, including an application authorization requirement, application owner's/team's details, be indicative of an application owner's/team's identity, an authorization permission level, or the like.

Additionally or alternatively, the method may include receiving a request from a requesting device, determining at least one application property indicative of an authority, requesting authorization from an authorizing device via a communications network using the application property, and selectively authorizing the request based upon the results of the authorization. In this regard, the authority may be any suitable authority, such as a user, identity, user group, or permission level, however, typically the authority is an application owner/team and the application property relating to the application owner/team, such as an email address.

In a further example, the method may include receiving a request from a requesting device, determining one or more application properties indicative of a notification property, providing a notification to a notification device via a communications network using the notification property, and optionally providing the results of the notification to the requesting device. For example, the notification property may include a user or list/group of users who require/have requested notification in the event a change is made or patch applied, or the like. This feature is particularly beneficial in situations where additional users require notification of a change, however, are not necessarily required to authorize the change.

Each of these authorization and/or notification examples may be performed in response to the receipt of any suitable request, such as a change request, asset patching request, application patching request, or a request to otherwise add, remove or modify data in the identifier store.

### Identifying Application Program(s)

A method for identifying one or more application programs associated with an asset will now be described. For this example, it is assumed the asset has one or more electronic asset processing devices configured to at least partially interact with the application program, as discussed above. The method includes, in one or more electronic processing devices (also as described herein) determining one or more asset identifiers indicative of the identity of the at least one asset, and retrieving one or more unique application identifiers from an identifier store using the asset identifier(s), each unique application identifier being indicative of one of application program(s). Thus, each asset may be interacting with one or more application programs. The method further includes providing an indication of the unique application identifier(s) to thereby allow the at least one application to be identified.

This method is particularly beneficial where, for example, an IT professional wishes to patch an asset, such as a server, and prior to proceeding wishes to ascertain which application programs may be impacted by patching the server. Alternatively, change management process may require that any changes to assets associated with an application program require the approval of an authorized person, such as the respective application program owners. Thus, this method facilitates the identification of the authorized person, and optionally the ability to subsequently request appropriate authorization.

Further features of this method include any of the features described herein in relation to other examples. Moreover, in a further example, a system for identifying one or more application programs associated with an asset includes an identifier store and the electronic processing device that performs the steps of the method described above.

### System

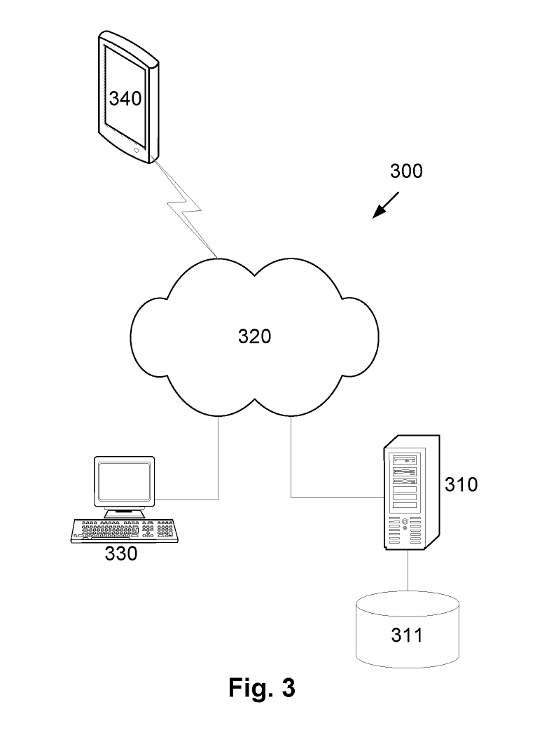

FIG. 3 provides an example of a system 300 for identifying a plurality of assets associated with an application program and/or for associating a plurality of assets with an application program. In this example, and as discussed above, each asset includes one or more electronic asset processing devices configured to at least partially interact with the application program.

The system 300 includes an identifier store 311 and an electronic processing device 310 that performs the steps of any of the methods described herein, and in one example, the methods described with reference to FIGS. 1A and 1B.

Optionally, the system may also include a communication network 320, which facilitates communication between the electronic processing device 310 and one or more user electronic processing devices 330, 340. Each user device 330, 340 may include any suitable processing device including any one or more of computer systems, processing devices, mobile communications devices, smart phones, tablets, such as described in any of the examples herein.

Thus, the user devices 330, 340 may form requesting devices which submit requests to the electronic processing device 310 to identify assets associated with application programs, associate assets and application programs, to modify, create, remove, patch, or otherwise change application program and/or asset properties and/or associations between assets and application programs.

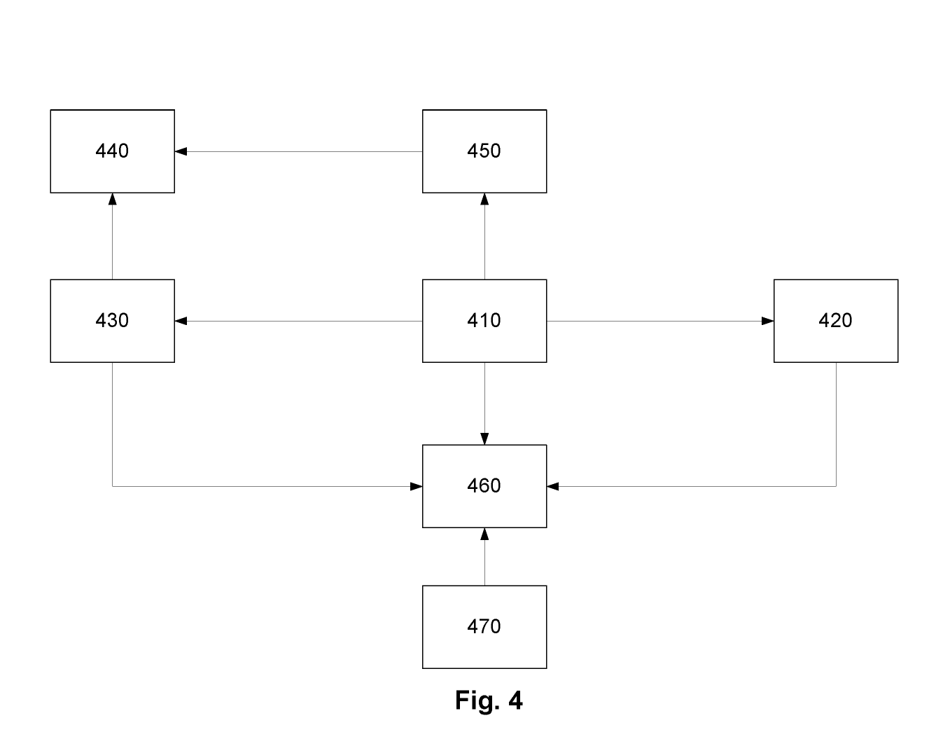

An example of a data flow in accordance with a method for identifying assets associated with an application program, and/or associating assets with the application program, will now be described with reference to FIG. 4.

In this example, a unique application identifier 410 and identifier store can be used, for example, by a change management tool 450, during server and/or asset patching 460 (and in one example by the UNIX administration team 470), and by an application owner/team 430 in order to identify, associate and manage application assets 420.

For example, the unique application identifier 410 and identifier store may be used to identify application programs in an organization for multiple lines of business, and their associated application assets 420 in respective environments, such as development (DEV), testing (TEST), and production (PROD). In addition, the unique application identifier 410 may be used to identify/access/store/modify/remove/create application program and/or asset properties/details within the identifier store, such as an application short name, an application owner/team name/details, an application contact list, a line of business, an asset version, asset hardware details, and the like. In addition, a new or decommissioned application programs (and/or asset) within the organization can be reflected in the identifier store using the unique application identifier 410, in order that information within the identifier store remains consistent with IT infrastructure.

In a change management process 440, the change management tool 450 may utilize the unique application identifier 410 to retrieve details relating to an application program with a predetermined environment (such as PROD). In this regard, the change management tool 450 may also receive, for example, the application owner's/team's name/details 430 and use this to seek appropriate approval for a desired change according to the change management process 440 or provide appropriate notifications. Accordingly, this provides the additional advantage of simplifying the change management process 440.

In respect of server and/or asset patching 460, the unique application identifier 410 and identifier store facilitates patching to be tracked according to application program and/or associated asset(s). For example, application and asset details may reflect patching history, as in some instances, it may be desirable to patch all assets within a business line/organization on a periodic basis (for example, quarterly). In addition, the identifier store and unique application identifier 410 may be used to ensure associated assets and application programs are patched in an optimal sequence, for example, in order to minimize impacts on IT operations. In some examples, server and/or asset patching 460 may be initiated and/or approved by the application owner/team 430 whose details are retrieved from the identifier store using the unique application identifier 410.

In one particular example, the UNIX administration team 470 may manage LINUX/UNIX patching and/or tracking for UNIX-related application programs and/or assets. Thus, the unique application identifier 410 and identifier store allows them to retrieve an application owner's/team's contact details easily in order to manage and/or communication a change relating to patching, particularly where the change requires an outage (such as a server outage). In addition, the UNIX admin team 470 may update application/asset details relating to respective UNIX/LINUX patching histories, server version details, a time/date the most recent patch was applied, and the like.

In addition, the data flow of FIG. 4 also allows an application owner/team 430 to easily manage/oversee application program and asset details using a unique application identifier 410 to access a single, consistent, accurate source (for example, the identifier store), which may, thus, be used for various purposes. In other examples, the unique application identifier 410 and identifier store may be used in other manners including configuration management, incident management, problem management, service level management, and the like.

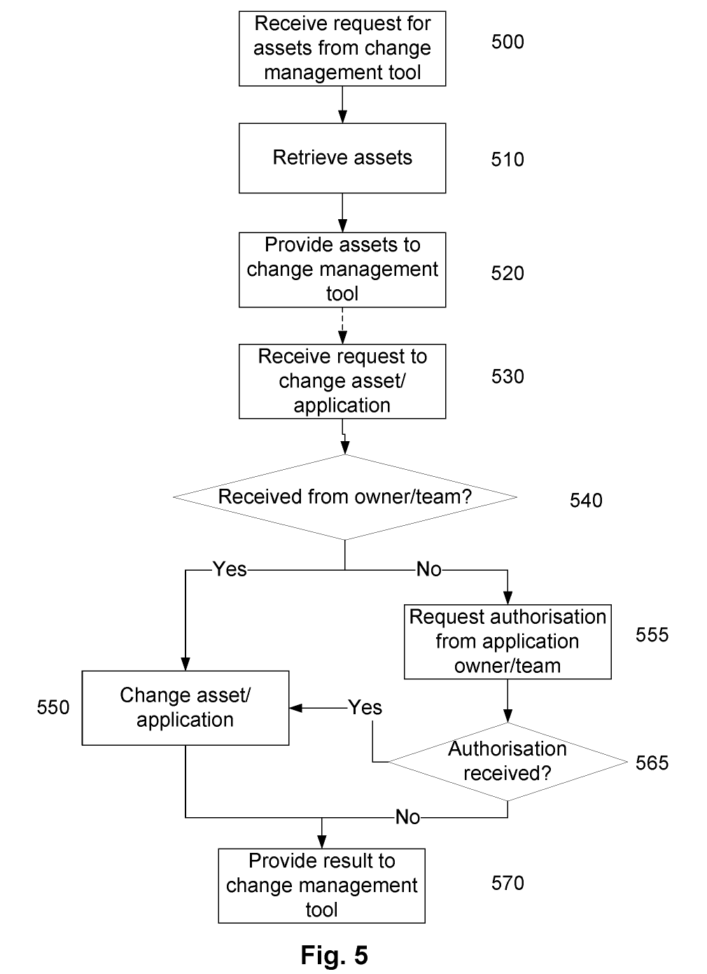

An example of a method for managing a change request for an application program and/or associated asset will now be described with reference to FIG. 5.

At step 500, the method includes, in an electronic processing device, receiving an asset request for the assets associated with the application program from a requesting device operating a change management tool, via a communication network. The asset request includes a unique application identifier which is indicative of the identity of the application program. The electronic processing device proceeds to retrieve the asset identifiers of the associated assets from an identifier store using the unique application identifier at step 510, together with application program properties including the application owner/team. These details are provided to the change management tool on the requesting device via the communication network, at step 520, allowing the change management tool to identify the relevant assets and perform any necessary actions.

Step 530 may occur at any time after step 520, where the electronic processing device receives a change request to modify one or more of the application or asset details from the change management tool, where the request includes the unique application identifier. Optionally, the method includes at step 540 determining if the application owner/team initiated the change request, and proceeding with the change request if it was initiated by the owner at step 550. If step 540 is unsuccessful or not performed, the processing device determines the application owner's/team's details using the unique application identifier and requests authorization from the application owner/team 555. If authorization is subsequently received, at step 565, the respective application/asset details may be changed/updated in accordance with the change request at step 550. Otherwise, the change request is denied. In any event, the results of the change request are provided to the change management tool at step 570.

In this example, a change request may include any suitable request to update, modify, remove, create, add, or otherwise alter data in the identifier store.

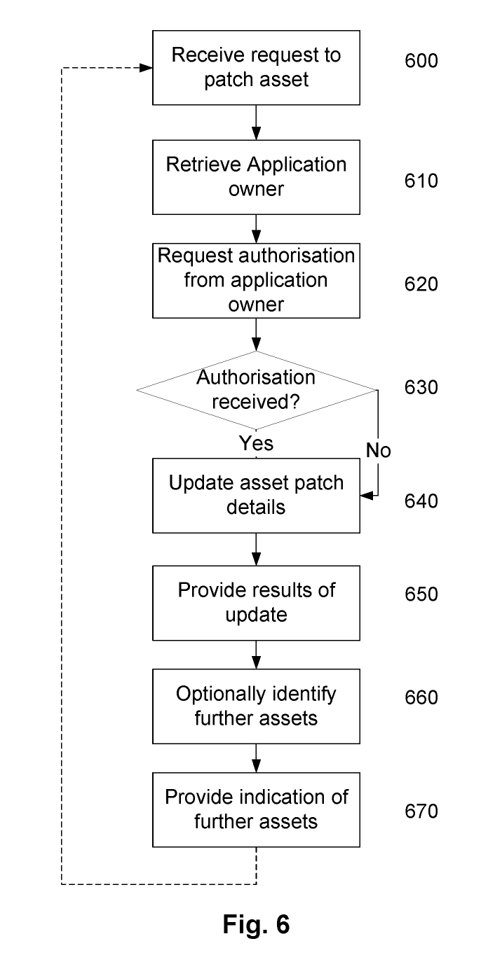

An example of a method for managing an asset patch request for an asset, the asset being associated with one or more application programs, will now be described with reference to FIG. 6. In this respect, a patch request may include a request to update the asset properties to reflect that a new patch was/will be installed or uninstalled, new firmware is/was updated/rolled back, or the like.

At step 600, the method includes in an electronic processing device, receiving from a requesting device an asset patch request to modify the patching details in respect of an asset where the asset patch request includes an asset identifier. At step 610, application owner/team details are retrieved from an identifier store using the asset identifier. In this regard, the application owner/team details may be associated with the asset identifier via the unique application identifier. In some examples, multiple application programs may be interacting with a single asset, therefore at step 610 multiple different application owner/team details may be retrieved.

At step 620, the processing device requests authorization for the asset patch request from each of the respective application owners′/teams' using the application owner/team details. If authorization is received, at step 630, the respective asset's patch history details are updated at step 640. The results of the patch update are provided to the requesting device at step 650.

In some instances it may be desirable to update the patch history of each asset associated with an application. Thus, at step 660 the method may also optionally include identifying further assets associated with the above-identified application programs(s) using the unique application identifiers, and providing these assets to the requesting device at step 670. Further asset patch requests for each of these additional assets may/may not subsequently be received and processed accordingly.

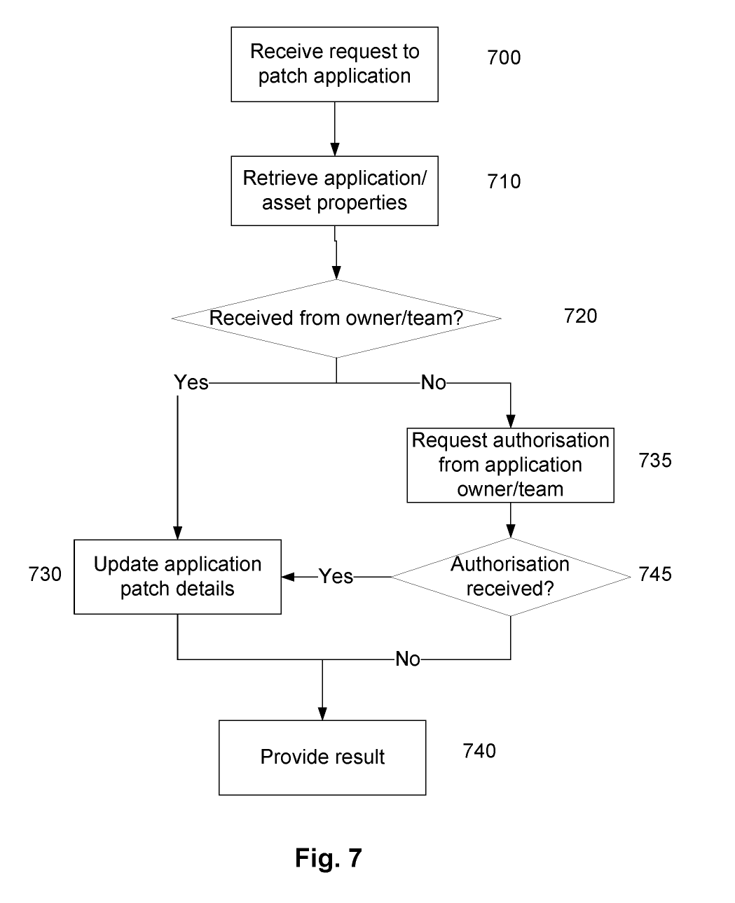

An example of a method for managing an application patch request for an application program, where the application program is associated with one or more assets, will now be described with reference to FIG. 7. In this respect, a patch request may include a request to update the application properties to reflect that a new patch was/will be installed or uninstalled, new firmware is/was updated/rolled back, or the like.

At step 700, the method includes receiving the application patch request to update the patch history of the application program, where the application patch request includes a unique application identifier indicative of the identity of the application program, and optionally the identity/details of a requestor.

At step 710, the processing device retrieves the application properties and associated assets from an identifier store using the unique application identifier. The application properties include the application owner's/team's details.

Optionally, the requestor and the application owner/team are compared at step 720, and if the owner requested the application patch request, the request is authorized and the application patch history is updated in the identifier store at step 730.

In the event step 720 is unsuccessful (or not performed), at step 735 the processing device uses the application owner's/team's details to request authorization for the application patch request from the application owner/team. At step 745 if authorization is received, the respective patch details are updated at step 730. If authorization is denied and/or not received, the application patch request is also denied. In any event, the results of the application patch request are provided at step 740.

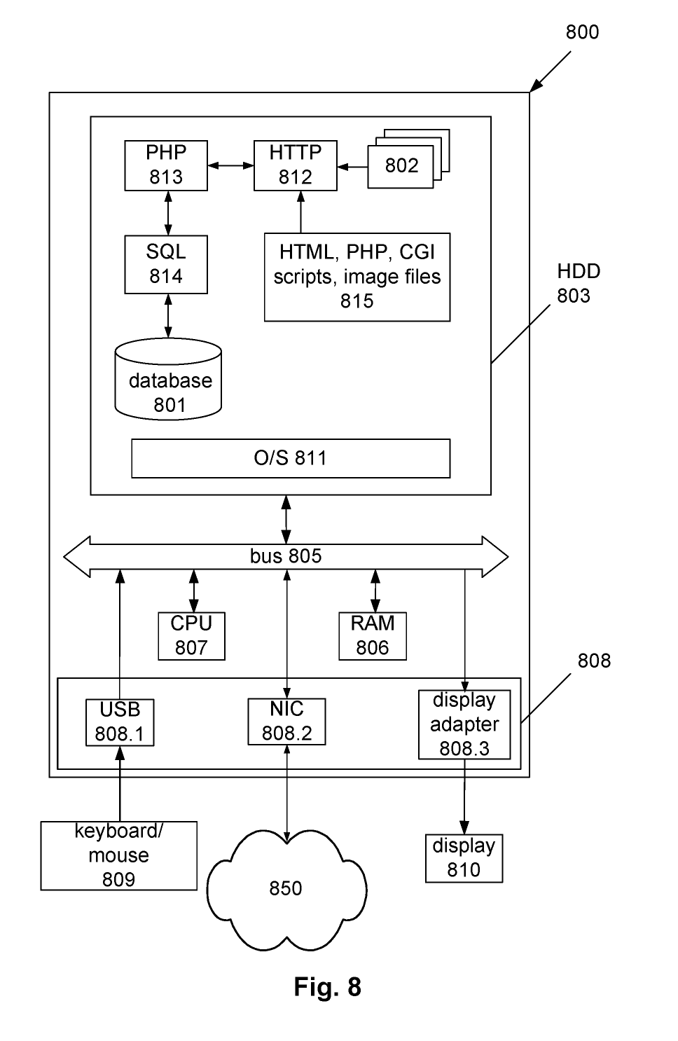

The electronic processing device, requesting device, user device, and/or electronic asset processing device of any of the examples herein may be formed of any suitable processing device, as previously discussed. One further example of such suitable device is shown in FIG. 8. In this example, a processing device is provided by a server 800 in communication with a database 801, as shown in FIG. 8. The computer system 800 is able to communicate with other processing devices, as required, over a communications network 850 using standard communication protocols. The database 801 may include an identifier store, or alternatively the identifier store may be external or peripheral to the server 800, such that, for example, the computer system 800 communicates with the identifier store over the communications network 850.

The components of the system 800 may be configured in a variety of ways. The components may be implemented entirely by software to be executed on standard computer server hardware, which may include one hardware unit or different computer hardware units distributed over various locations, some of which may require the communications network 850 for communication. A number of the components or parts thereof may also be implemented by application specific integrated circuits (ASICs) or field programmable gate arrays.

In the example shown in FIG. 8, the computer system 800 is a commercially available server computer system based on a 32 bit or a 64 bit Intel architecture, and the processes and/or methods executed or performed by the computer system 800 are implemented in the form of programming instructions of one or more software components or modules 802 stored on non-volatile (e.g., hard disk) computer-readable storage 803 associated with the computer system 800. At least parts of the software modules 802 could alternatively be implemented as one or more dedicated hardware components, such as application-specific integrated circuits (ASICs) and/or field programmable gate arrays (FPGAs).

The computer system 800 includes at least one or more of the following standard, commercially available, computer components, all interconnected by a bus 805:
1. random access memory (RAM) 806;
2. at least one computer processor 807, and
3. external computer interfaces 808:
   a. universal serial bus (USB) interfaces 808.1 (at least one of which is connected to one or more user-interface devices, such as a keyboard, a pointing device (e.g., a mouse 809 or touchpad),
   b. a network interface connector (NIC) 808.2 which connects the computer system 800 to a data communications network, such as the Internet 850; and
   c. a display adapter 808.3, which is connected to a display device 810 such as a liquid-crystal display (LCD) panel device.

The computer system 800 includes a plurality of standard software modules, including:
1. an operating system (OS) 811 (e.g., Linux or Microsoft Windows);
2. web server software 812 (e.g., Apache, available at http://www.apache.org);
3. scripting language modules 813 (e.g., personal home page or PHP, available at http://www.php.net, or Microsoft ASP); and
4. structured query language (SQL) modules 814 (e.g., MySQL, available from http://www.mysql.com), which allow data to be stored in and retrieved/accessed from an SQL database 801.

Together, the web server 812, scripting language 813, and SQL modules 814 provide the computer system 800 with the general ability to allow users of the Internet 850 with standard computing devices equipped with standard web browser software to access the computer system 800 and in particular to provide data to and receive data from the database 801. It will be understood by those skilled in the art that the specific functionality provided by the system 800 to such users is provided by scripts accessible by the web server 812, including the one or more software modules 802 implementing the processes performed by the computer system 800, and also any other scripts and supporting data 815, including markup language (e.g., HTML, XML) scripts, PHP (or ASP), and/or CGI scripts, image files, style sheets, and the like.

The boundaries between the modules and components in the software modules 802 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the disclosure. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the steps of the processes performed by the computer system 800 may be executed by a module (of software modules 802) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The computer system 800 normally processes information according to a program (a list of internally stored instructions such as a particular application program and/or an operating system) and produces resultant output information via input/output (I/O) devices 808. A computer process typically includes an executing (running) program or portion of a program, current program values and state information, and the resources used by the operating system to manage the execution of the process. A parent process may spawn other child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

In other examples, the electronic processing device is formed of multiple computer systems interacting, for example, via a distributed network arrangement. As distributed networking is known in the art, it will not be described further in more detail.

In any event, the methods and systems described above provide a unique application identifier which allows the identification of associated assets. This is particularly beneficial as it facilitates the management and tracking of asset and application changes, thus minimizing the impact of those changes on IT infrastructure and operations.

Throughout this specification and claims which follow, unless the context requires otherwise, the word “include”, and variations such as “includes” or “including”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art should be considered to fall within the spirit and scope that the disclosure broadly appearing before described.

1. A computer-implemented method for identifying at least one asset associated with an application program, each of the at least one asset having at least one electronic asset processing device configured to at least partially interact with the application program, the method comprising:
determining a unique application identifier indicative of an identity of the application program;
retrieving at least one asset identifier from an identifier store using the unique application identifier, the at least one asset identifier being indicative of the at least one asset; and
providing an indication of the at least one asset identifier to thereby allow the the at least one asset to be identified.

2. A method according to claim 1, wherein the method comprises determining the unique application identifier in accordance with user input commands.

3. A method according to claim 1, wherein retrieving the asset identifier includes, in the electronic processing device:
retrieving an association from the identifier store, the association being indicative of the unique application identifier and the at least one asset identifier; and
determining the at least one asset identifier using the association.

4. A method according to claim 1, wherein the method comprises, in the electronic processing device:
receiving an asset request via a communications network from a requesting device, the asset request including an indication of the application identifier; and
providing the indication of the at least one asset identifier to the requesting device via the communication network.

5. A method according to claim 1, wherein interacting with the application program includes at least one of:
operating the application program;
executing the application program; and
interfacing with the application program.

6. A method according to claim 1, wherein the method comprises, in the electronic processing device:
determining an environment identifier indicative of an application environment of the application program; and
retrieving the asset identifier from the identifier store using the environment identifier and the unique application identifier.

7. A method according to claim 1, wherein the method comprises, in the electronic processing device:
retrieving at least one application property from the identifier store using the unique application identifier; and
providing an indication of the application property.

8. A method according to claim 1, wherein the method comprises, in the electronic processing device:
receiving an application update request to update an application property, the request including an updated application property value;
updating the application property with the updated application property value; and
selectively indicating whether the update was successful.

9. A method according to claim 7, wherein the application property includes at least one of:
an application name;
an application short name;
an application owner/team;
an application environment;
an approver;
an organization;
an application contact; and
a line of business.

10. A method according to claim 1, wherein the method comprises, in the electronic processing device:
retrieving at least one asset property from the identifier store, the asset property being indicative of a property of the asset using the asset identifier; and
providing an indication of the at least one asset property.

11. A method according to claim 1, wherein the method comprises, in the electronic processing device:
receiving an asset update request to update an asset property, the request including an updated asset property value;
updating the asset property with the updated asset property value; and
selectively indicating whether the update was successful.

12. A method according to claim 11, wherein the asset property includes at least one of:
at least one version identifier;
a version history;
a patch history;
a patch identifier;
an operating system identifier;
a hardware specification; and
a hardware identifier.

13. A method according to claim 1, wherein the method comprises, in the electronic processing device:
receiving an asset disassociate request to disassociate at least one of the at least one assets from the application program, the request including respective asset identifiers;
disassociating the respective asset identifier and the unique application identifier in the identifier store; and
selectively indicating whether the disassociation was successful.

14. A method according to claim 1, wherein the method comprises, in the electronic processing device:
receiving an application disassociate request to disassociate the application, the request includes the unique application identifier;
disassociating the unique application identifier and each of the at least one asset identifiers in the identifier store; and
selectively indicating whether the disassociation was successful.

15. A method according to claim 13, wherein disassociating includes at least one of decommissioning, removing, and deleting.

16. A method according to claim 1, wherein the method comprises, in the electronic processing device:
receiving a request from a requesting device, the request including an authorization parameter;
comparing the authorization parameter and at least one of the application properties; and
selectively authorizing the request based upon the results of the comparison.

17. A method according to claim 1, wherein the method comprises, in the electronic processing device:
receiving a request from a requesting device;
determining at least one application property indicative of an authority;
requesting authorization from an authorizing device via a communications network using the application property; and
selectively authorizing the request based upon the results of the authorization.

18. A method according to claim 1, wherein the asset includes any one of:
a web server;
an application server; and
a database server.

19. A computer-implemented method for associating at least one asset with an application program, each of the at least one asset having at least one electronic asset processing device configured to at least partially interact with the application program, the method comprising:
determining a unique application identifier indicative of an identity of the application program;
determining at least one asset identifier indicative of the identity of the at least one asset;
associating the at least one asset identifier and the unique application identifier; and
storing the association in an identifier store, thereby associating the at least one asset and the application program.

20. A method according to claim 19, wherein determining a unique application identifier includes at least one of:
generating a unique value; and
retrieving a unique value from a store.

21. A method according to claim 19,
wherein determining the unique application identifier includes, in the electronic processing device, generating a unique value at least partially using an environment identifier, the environment identifier being indicative of an application environment.

22. A method for identifying at least one application program associated with an asset, the asset having at least one electronic asset processing device configured to at least partially interact with the application program, the method comprising:
determining at least one asset identifier indicative of the identity of the at least one asset;
retrieving at least one unique application identifier from an identifier store using the at least one asset identifier, each unique application identifier being indicative of one of the at least one application programs; and
providing an indication of the at least one unique application identifier to thereby allow the at least one application to be identified.

23. A system for identifying a plurality of assets associated with an application program, each asset including at least one electronic asset processing device configured to at least partially interact with the application program, the system comprising:
an identifier store; and
at least one electronic processing device that:
determines a unique application identifier indicative of the identity of the application program;
retrieves a plurality of asset identifiers from the identifier store using the unique application identifier, each asset identifier being indicative of at least one of the plurality of assets; and
provides an indication of the asset identifiers to thereby allow the assets to be identified.

24. A system according to claim 23, wherein retrieving the asset identifier includes, in the electronic processing device:
retrieving an association from the identifier store, the association being indicative of the unique application identifier and the at least one asset identifier; and
determining the at least one asset identifier using the association.

25. A system for associating a plurality of assets with an application program, each asset including at least one electronic asset processing device configured to at least partially interact with the application program, the system comprising:
an identifier store; and
at least one electronic processing device that:
determines a unique application identifier indicative of an identity of the application program;
determines an asset identifier indicative of the identity of each of the plurality of assets;
associates each of the asset identifiers and the unique application identifier; and
stores each association in the identifier store, thereby associating the assets and the application program.
